(19) United States
(12) Patent Application Publication
(10) Pub. No.: US 2008/0308125 A1
(43) Pub. Date: Dec. 18, 2008

(54) Apparatus and Method for Cleaning a Sawn Wafer Block

(75) Inventors: Wolfgang Stangl, Eichenau (DE); Hans-Juergen Stangl, Neuhausen o. E. (DE)

Correspondence Address: SCHOPPE, ZIMMERMANN , STOCKELER & ZINKLER;C/O KEATING & BENNETT , LLP, 1800 Alexander Bell Drive, SUITE 200, Reston, VA, 20191, US

(73) Assignee: STANGL SEMICONDUCTOR EQUIPMENT AG, Eichenau (DE)

(21) Appl. No.: 12/096,227

(22) PCT Filed: Dec. 6, 2006
(86) PCT No.: PCT/EP2006/011724

§ 371 Date: Jun. 30, 2008

(30) Foreign Application Priority Data
Dec. 6, 2005 (DE) 10 2005 058 269.9

(51) Int. Cl. B08B 3/10; B08B 13/00; B08B 15/00

(52) U.S. Cl. 134/10; 134/201; 134/198; 134/172; 134/199; 134/109; 134/21

(57) ABSTRACT

An apparatus for cleaning a sawn wafer block includes a cleaning basin, a fixture for holding a sawn wafer block in the cleaning basin such that, when cleaning liquid is present in the cleaning basin, at least a portion of the wafer block having sawn gaps is disposed in the cleaning liquid, at least one outlet port in a bottom region of the cleaning basin, and a closer for the outlet port, by means of which the outlet port may be opened and closed. The closer, the outlet port and the bottom region of the cleaning basin are configured such that, by opening the closer the cleaning liquid is drainable so fast from at least the area of the cleaning basin having the wafer block disposed therein that contaminants are removable from the sawn gaps due to a suction effect of the cleaning liquid.

### TECHNICAL FIELD

The present invention relates to an apparatus and a method for cleaning a sawn wafer block, in particular to an apparatus and a method suitable for cleaning wafer blocks sawn by means of a wire saw, in order to remove slurry remnants as well as sawing residues from the sawn gaps between the wafers.

### SUMMARY

According to an embodiment, an apparatus for cleaning a sawn wafer block may have: a cleaning basin; a fixture for holding a sawn wafer block in the cleaning basin such that, when cleaning liquid is present in the cleaning basin, at least a portion of the wafer block having sawn gaps is disposed in the cleaning liquid; at least one outlet port in a bottom region of the cleaning basin; and a closer for the outlet port, by means of which the outlet port may be opened and closed, wherein the closer, the outlet port and the bottom region of the cleaning basin are configured such that, by opening the closer, the cleaning liquid is drainable from at least the area of the cleaning basin having the wafer block disposed therein so fast that contaminants are removable from the sawn gaps by means of a suction effect of the cleaning liquid, wherein the outlet port and the closer are configured such that the cleaning basin, starting from a filled state monitored via a sensor, is drainable in less than 2 seconds, advantageously less than 1.5 seconds.

According to another embodiment, an apparatus for cleaning a sawn wafer block may have: a cleaning basin; a fixture for holding a sawn wafer block in the cleaning basin such that, when cleaning liquid is present in the cleaning basin, at least a portion of the wafer block having sawn gaps is disposed in the cleaning liquid; at least one outlet port in a bottom region of the cleaning basin; and a closer for the outlet port, by means of which the outlet port may be opened and closed, wherein the closer, the outlet port and the bottom region of the cleaning basin are configured such that, by opening the closer, the cleaning liquid is drainable from at least the area of the cleaning basin having the wafer block disposed therein so fast that contaminants are removable from the sawn gaps by means of a suction effect of the cleaning liquid, wherein the cleaning basin exhibits a length and a width, wherein the at least one outlet port continuously extends across the entire length of the cleaning basin.

According to another embodiment, an apparatus for cleaning a sawn wafer block may have: a cleaning basin; a fixture for holding a sawn wafer block in the cleaning basin such that, when cleaning liquid is present in the cleaning basin, at least a portion of the wafer block having sawn gaps is disposed in the cleaning liquid; at least one outlet port in a bottom region of the cleaning basin; and a closer for the outlet port, by means of which the outlet port may be opened and closed, wherein the closer, the outlet port and the bottom region of the cleaning basin are configured such that, by opening the closer, the cleaning liquid is drainable from at least the area of the cleaning basin having the wafer block disposed therein so fast that contaminants are removable from the sawn gaps by means of a suction effect of the cleaning liquid, wherein the outlet port is formed in a bottom plate of the cleaning basin, wherein the closer includes a closure element and a driver for moving the closure element in a vertical direction, wherein sealing surfaces of the outlet port, at which the closure element, when same is in a closed position, closes the outlet port, are arranged in an inclined manner so that the outlet port is smaller on the top side of the bottom plate than on the underside thereof, wherein the closure element includes matching sealing surfaces arranged in an inclined manner.

According to another embodiment, a method of cleaning a sawn wafer block may have the steps of: introducing the sawn wafer block into a cleaning basin; filling the cleaning basin with cleaning liquid prior to, during or after introducing the sawn wafer block so that at least a portion of the wafer block having sawn gaps is located in the cleaning liquid; opening at least one outlet port arranged in the bottom region of the cleaning basin, the outlet port and the bottom region of the cleaning basin being formed such that the cleaning liquid, by opening same, is drained so fast that contaminants are removed from the sawn gaps due to a suction effect of the cleaning liquid, wherein the cleaning basin is drained in less than 2 seconds, advantageously less than 1.5 seconds.

The present invention is therefore based on a cleaning effect based on the suction effect of cleaning liquid (generally water) flowing out of a cleaning basin so as to pull off and remove contaminants such as slurry remnants and sawing residues located between the wafers inside the sawn gaps.

Here, the outlet ports and the bottom region are configured to support fast drainage of the cleaning basin, e.g. in a period of less than 2 seconds, advantageously less than 1.5 seconds and e.g. in the span of 1 second.

For supporting fast drainage, the cleaning basin may comprise wall regions leading to the outlet port in an inclined manner. For example, the cleaning basin may comprise two outlet ports, between which a roof-shaped bottom region is arranged. The one or more outlet ports may continuously extend along substantially the entire length of the cleaning basin. Moreover, in order to prevent contaminants depositing, it may be advantageous to design the cleaning basin such that it comprises no horizontal inner surfaces.

For enabling fast drainage, in embodiments of the invention, one or more outlet ports may be formed in a bottom plate of the cleaning basin, wherein the closure means comprises a closure element and drive means for moving the closure element in a vertical direction. For enabling fast drainage with this setup, sealing surfaces of the outlet port, at which the closure element, when same is in a closure position, closes the outlet port are arranged in an inclined manner so that the outlet port is smaller on the top side of the bottom plate than on the underside thereof, wherein the closure element comprises matching sealing surfaces arranged in an inclined manner. In other words, the closure element may exhibit a roof-like structure.

In embodiments of the present invention, furthermore sprayers may be provided in the cleaning basin so as to spray cleaning liquid into the sawn gap from one or two sides. Here, spraying processes may take place both while the wafers are disposed in the cleaning liquid and with the cleaning basin drained, i.e. when the wafers are not located in the cleaning liquid. By means of spraying with the wafer blocks being immersed in the cleaning liquid, the permeating performance of water into the sawn gaps and related future cleaning of the block by opening the outlet port may be improved. The sprayer may comprise spray strips on both sides of the wafer block, for example, so that it is possible to spray cleaning liquid into all sawn gaps. The spray strips may be embodied such that they can be lifted and lowered so as to further improve the cleaning of the block. Finally, the cleaning of the block may be improved by spraying alternatingly from both sides.

For performing the inventive method, water is advantageously used as the cleaning liquid. For supporting the cleaning process, small quantities of a surfactant may be added. In addition, the cleaning liquid may be heated to support the cleaning process.

The inventive apparatus and the inventive method may be configured for enabling automated cleaning of wafer blocks. For this purpose, an automatic handing system may be provided, which feeds the sawn wafer blocks from a previous processing station to a station comprising the inventive cleaning apparatus and after the cleaning feeds the sawn wafer blocks from this cleaning station to a post-processing station. Furthermore, the inventive apparatus may comprise suitable control means for implementing different cleaning concepts each having one or more spraying processes and/or draining processes.

The inventive apparatus may further comprise an installation for preparing and recycling the contaminated cleaning liquid accruing. Such a recycling installation may comprise e.g. a centrifuge the contaminated cleaning liquid is fed to in order to discharge solid matter therefrom so as to create a cleaned cleaning liquid, which is then again fed to the cleaning apparatus.

### BRIEF DESCRIPTION OF THE DRAWINGS

Embodiments of the present invention will be detailed subsequently referring to the appended drawings, in which:

FIG. 1 shows a schematic cross-sectional view of an embodiment of an inventive cleaning apparatus with outlet ports closed;

FIG. 2 shows a schematic representation of the embodiment shown in FIG. 1 with the outlet ports opened;

FIG. 3 schematically shows a view of the bottom of the cleaning basin for illustrating the shape of the outlet ports; and

FIG. 4 schematically shows an embodiment of a recycling installation.

### DETAILED DESCRIPTION

Before specific embodiments of the present invention are addressed referring to the figures, what is briefly outlined first is how the present invention is embedded in the process of wafer fabrication.

First, wafer blocks are attached to support beams made of glass or plastic using an adhesive and/or lute. By means of the support beams, the wafer blocks are fed to a wire saw, where the wafer blocks are sawn into wafers, which at one end thereof are glued to the support beams.

Out of the wire saw, the sawn wafer blocks may be inserted into a transport and process basket, for example, which in turn may be inserted into a special transport carriage that may be able to accommodate up to four process baskets and transport same to the cleaning installation. The transport carriage may be docked to the cleaning station via a docking station. The container of the transport carriage the baskets are inserted into may be filled with a cleaning medium, which in docking to the cleaning installation may be drained and filled with a fresh medium.

There may be provided a 3-axes handling system for removing the process baskets from the transport carriage by means of pick-up hooks, inserting same into an input buffer station and conveying same from there through the cleaning installation. After the cleaning process, the process baskets are automatically moved into deluting basins. The process baskets used may be equipped with foldable brushes, which are not applied to the wafers until the baskets are inserted into the deluting basin via a lever mechanism, whereby the wafers are retained in a vertical position (for automatic dicing) after detachment from the support beam. The deluting basin is embodied with a water-sealed cover, the wafers being detached from the support beam and deluted therein in acetic acid/formic acid approximately 70° C. hot. Here, the glue remains completely adherent to the support beam so that no glue residues will remain on the wafer. After detaching the wafers, the support beams with the glue adherent thereto are automatically detached from the process basket, together with a machine support to which they are attached, so as to be prepared for repeated use.

After the deluting described, the acetic acid is drained from the deluting basin, and a spraying and rinsing process is performed in the same basin. This has the effect that the H2 concentration in the basin is decreased to a harmless concentration and the process temperature in the receiver tank may be tracked.

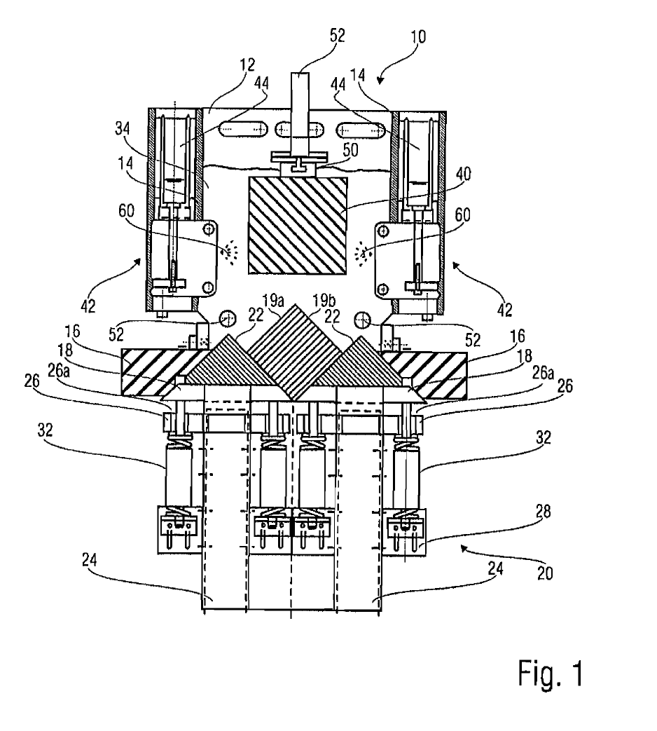

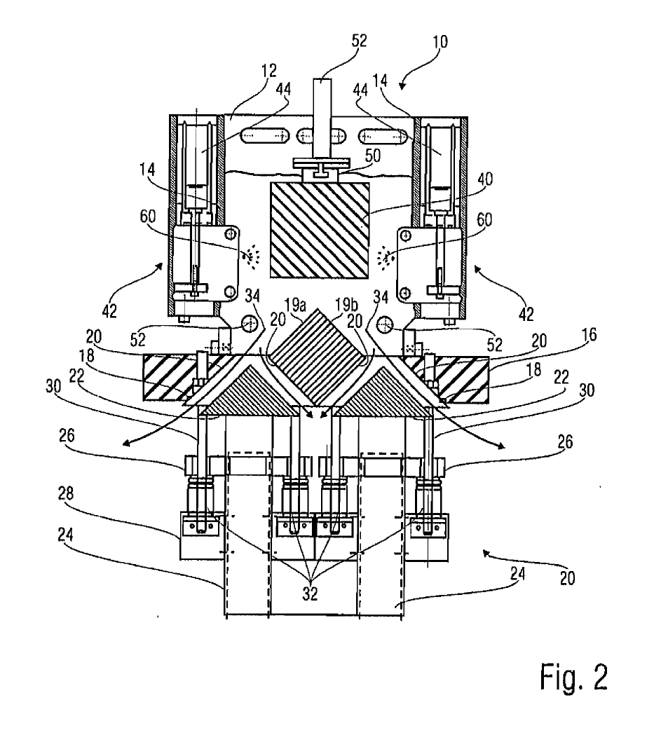

The inventive cleaning of the sawn wafer blocks is described in the following with respect to FIGS. 1, 2 and 3. FIGS. 1 and 2 are schematic cross-sectional views, in which parts that are hidden as such are illustrated in a dashed manner so as to enable explaining the invention, and in which, for the purpose of clarity, not all of the sawn surfaces are hatched.

The embodiment of the inventive cleaning apparatus shown comprises a cleaning basin 10 having a rear panel 12, sidepanels 14 and a front panel, which is not shown in the figures. The cleaning basin further comprises a bottom region formed by a bottom plate 16 having outlet ports 18 formed therein. The outlet ports 18 have edges 20 running in an inclined manner so that the outlet ports 20 are trapezoidal in the section shown in FIG. 2.

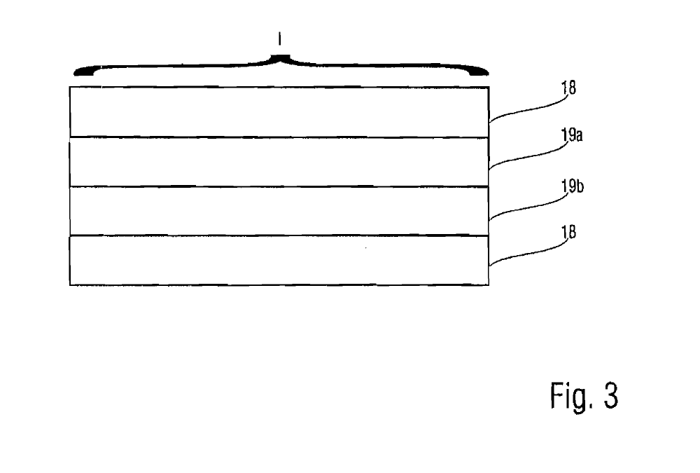

A top view of the bottom 16 of the cleaning basin 10 with the outlet ports 18 formed therein is shown in FIG. 3. Here, the length l represents the dimension into the plane of projection according to FIGS. 1 and 2. As can be seen, the outlet ports 18 run across the entire length l along the two sides of the bottom of the cleaning basin 10. Between the outlet ports, the bottom plate exhibits a roof-shaped course with inclined surfaces 19a and 19b, leading towards the outlet ports 18 in an inclined downward manner. On the outer edges, the outlet ports border on the side panels of the cleaning basin. Alternatively, there, bottom region sloping downward in an inclined manner could again be present. Arranging the outlet ports along both sides of the cleaning basin together with the wedge-shaped portion of the bottom plate arranged therebetween (see surfaces 19a and 19b in FIG. 2) is particularly advantageous as this serves to enable fast and substantially eddy-free drainage of the cleaning basin.

The outlet ports 18 may be closed by closure means 20 comprising closure elements 22 and a drive mechanism for moving the closure elements 22 in a vertical direction. The closure elements 22 are attached to support elements 24, which in turn are attached to one or more yokes 26. The fixture 28 is rigidly attached to the basin bottom 16 via guide bars 30 (FIG. 2), e.g. via screw joints, which are indicated in the figures. The guide bars 30 extend through recesses 26a in the yokes 26. Between the yokes 26 and the fixture 28, spring and cylinder mechanisms 32 are provided, by means of which the yoke and therefore the closure elements 22 rigidly attached to the yokes are movable in a vertical direction.

In the state shown in FIG. 1, the closure elements are pressed against the basin bottom 16 by means of the springs and cylinders 32 so that the cleaning basin 10 is sealed below and therefore shut with respect to cleaning liquid 34 located therein. In FIG. 2, the basin is shown opened, wherein the springs are compressed so that the yokes 26 and closure elements 22 rigidly joined thereto are vertically moved downward so that the openings 18 in the basin bottom 16 are open. Therefore, the cleaning liquid may issue from the cleaning basin along the arrows 34 shown in FIG. 2.

As can be gathered from FIGS. 1 and 2, the closure elements 22 have a roof-shaped structure, wherein the roof surfaces run at an angle substantially identical to that of the inclined regions 20 of the outlet ports 18 so that, in the state of rest shown in FIG. 1, the bottom of the cleaning basin is sealed.

In addition, in the embodiment shown, sprayers 42 are arranged on both sides of a sawn wafer 40 disposed in the cleaning basin. The sprayers 42 each comprise a row of spray nozzles extending into the image plane in the representations of FIGS. 1 and 2 so that a plurality of sawn gaps arranged one after the other in the representation may be sprayed into by these spray nozzles. In addition, drive means 44 are provided for the sprayers 42 so as to move same in a vertical direction.

As has been mentioned above, the sawn wafer block 40 is glued to a support beam 50. A fixture 52, which may be part of an automatic 3-axes handling system, holds the sawn wafer block 40 in the cleaning basin. Here, the wafer block 40 may be disposed in a process basket adapted for this purpose and being configured to not impair the rinsing and spraying processes described hereinafter.

Furthermore, closable inflow apertures 52 are provided in the embodiment, via which the cleaning basin 10 may be filled with a cleaning liquid, advantageously water.

For performing an inventive suction cleaning process, the cleaning basin 10 is first filled with water via inflows 52. Here, the outlet elements 22 are in the position shown in FIG. 1 so that the outlets 18 are closed. The basin continues to be filled until the entire block 40 is submerged. The filling procedure may be monitored via a sensor. After the filling, the block may remain in the water for a predetermined period of time so as to improve the permeating performance of the water between the individual wafers and therefore the cleaning effect. In addition, spraying may take place under water as is indicated in FIG. 1 in the form of spray beams 60 coming from both sides. This serves to improve the permeating performance into the sawn gaps.

Subsequently, the drive means 20 for the closure elements 22 is actuated so that the closure elements 22 are vertically moved downward. As a result, the outlet ports 18 of the basin are abruptly opened, and the closure elements moved downward will clear a large drainage cross-section. In the process, the cleaning basin is completely drained in the span of 1 second. The fast drainage causes a suction effect between the wafer disks, whereby slurry remnants as well as sawing residues located between the wafer disks are rinsed off.

The fast drainage is aided by the surfaces 19a and 19b in the cleaning basin running backward in an inclined manner towards the outlet ports 18. In addition, as the cleaning basin is designed entirely without any horizontal surfaces in the region where the cleaning liquid is located, a depositing of contaminants may substantially completely be prevented.

Apart from the suction cleaning process described, a further basic cleaning mode consists in a spraying process using the sprayers 42. Same may comprise nozzles directed at the wafer block such as flat-spray nozzles or the like, which may be screwed into a spray strip and are installed on both sides of the basin in two rows. As a result of spraying the block with water both under water and with the cleaning basin drained, the dirt located between the wafers is peeled off and rinsed out. Alternating spraying by the liftable and lowerable spray strips may substantially enhance the cleaning result. By alternating spraying from the left- and right-hand sides, dirt may be moved to the left- and right-hand sides and in the process be transported downward and out of the sawn gaps. By appropriate spray-angle adjustment of the spray nozzles, the zone below the glue beam 50 may also be reached.

The inventive cleaning apparatus advantageously comprises a suitable controller, by means of which the processes described may be performed in an automated manner. A programmable logic control having several cleaning recipes stored therein may be used, for example. Such varying cleaning recipes may refer to different suction process steps and spraying process steps for different wafer sizes, block gluing settings and the like.

By repeating individual suction cleaning steps and/or spray cleaning steps, enhanced results may be obtained.

In an exemplary cleaning process, the wafer block is first inserted into the filled cleaning basin 10. Subsequently, the wafer block is left in the cleaning basin for a residence time, wherein six sequences of underwater spraying are conducted. The individual spraying processes may comprise simultaneous alternating spray variations of different durations, in which the spray nozzles are lifted and lowered along the block. Following this, there are three suction cleaning processes, wherein underwater spraying may additionally be performed after the basin is filled. Here, the cleaning period ranged from approximately 20 to 25 minutes, wherein e.g. four basins may be provided in the production installation, resulting in a process time per block of approximately 5 to 6 minutes.

Alternatively, the spray nozzles with adjustable spray angles may be provided so that lowering and lifting same is no longer mandatory.

Referring to FIGS. 1 to 3, an embodiment with respect to the outlet ports, the closure elements and the bottom region was described. For people skilled in the art, however, it is obvious that the outlet ports, the closure elements and the bottom region may exhibit different shapes as long as the ports are capable of being opened quickly and the drainage cross-section ensures that sufficiently fast drainage of the cleaning basin may take place so as to achieve a suction effect suitable for removing contaminants from the sawn gaps.

With respect thereto, outlet ports may e.g. be provided with flaps capable of being opened sufficiently fast. Alternatively, closure elements horizontally movable relative to the outlet ports may be provided as long as same are capable of being moved sufficiently fast so as to clear the outlet ports.

Finally, the two outlet ports 18 running in parallel to each other, which are shown in FIG. 3, are exemplary only, wherein outlet ports of other shapes and sizes may be provided as long as the drainage cross-section remains sufficiently large so as to enable drainage fast enough to cause the suction effect described. With respect to this, for example one single outlet port in the center of the bottom of the cleaning basin could be provided, with inclinedly sloping panel regions leading thereto from two or more sides.

The inventive cleaning apparatus may further comprise an installation for recycling contaminated cleaning liquid accruing in cleaning the sawn wafer blocks. Same may for example comprise a centrifuge for discharging solid matter from the contaminated cleaning liquid so as to produce cleaned cleaning liquid, inflow means for feeding contaminated cleaning liquid from the cleaning apparatus to the centrifuge and backflow means for feeding the cleaned cleaning liquid from the centrifuge back to the cleaning apparatus.

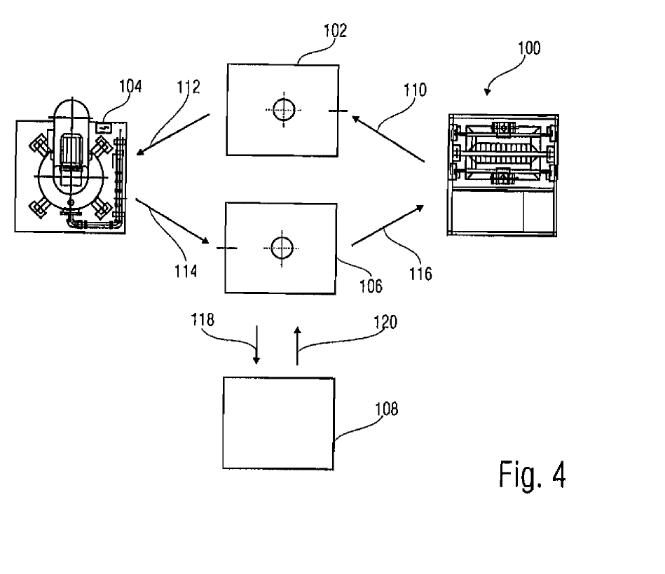

One example of such an installation is shown in FIG. 4. The installation comprises an inventive apparatus 100 for cleaning sawn wafer blocks, a waste container 102, a centrifuge 104 and a clean container 106. Optionally, a filter 108 that may be filtered by a band filter or a chamber filter press may additionally be provided.

The wastewater accruing in draining the cleaning basin of the cleaning apparatus 100 is collected in a collecting pan (not shown) of the cleaning apparatus 100. From this collecting pan, the wastewater is pumped into a receiver container, i.e. the waste container 102, as indicated in FIG. 4 by an arrow 110. From the waste container 102, the centrifuge 104 is continuously charged, as indicated in FIG. 4 by means of the arrow 112. For this purpose, an outlet of the waste container 102 is connected to an inlet of the centrifuge 104 via a fluid line. Respective pumping means for continuous charging of the centrifuge is also provided.

In the centrifuge, a rotation is applied to the wastewater (the cleaning medium) so that solid matter is discharged from the water. The smaller the volume flow conveyed into the centrifuge 104, and therefore the longer the residence time of the water in the centrifuge 104, the better the solid-matter discharge and therefore the cleaning result. After separation of the solid matter, the centrifuge conveys the water on to a receiver container, the clean container 106. This is indicated in FIG. 4 by means of an arrow 114. For this purpose, an outlet of the centrifuge 104 is connected to an inlet of the clean container 106 via a respective fluid line.

The outlet of the clean container 106 is in turn connected to an inlet of the cleaning installation (e.g. via a respective fluid line) so that the cleaned water may be fed back to the cleaning installation 100, as indicated in FIG. 4 by means of an arrow 116. The water is therefore available again for further cleaning processes.

The centrifuge 104 may be configured for not discharging small particles of a size or diameter of less than 5 μm from the cleaning liquid, which is usually water. It has been found that particles less than 5 μm will agglomerate and may therefore also be segregated in a later, e.g. the next, run via the centrifuge 104.

For also segregating the particles of a size of less than 5 μm from the water, the filter 108 may optionally be provided. The filter 108 is driven in parallel to the above-mentioned recycling, wherein cleaning liquid is conveyed from the clean container 106 to the filter 108, as indicated by means of an arrow 118, and then pumped back from the filter 108 to the clean container 106, as indicated by FIG. 4 by arrow 120. For this purpose, a respective inlet and outlet of the filter 108 may be connected to respective fluid lines. In addition, respective pumps may again be provided so as to pump the water through the parallel circuit containing the filter 108.

For counteracting an accumulation of small and minute particles in the clean container and/or clean tank 106 via the timeline, freshwater may be added to the circuit, e.g. to the clean container, with circuit water simultaneously being discarded from the clean container 106, the circuit water, due to its very small proportion of solid matter, being capable of directly being conducted into the sewer system. Approximately 50 liters of freshwater, for example, may be added for each sawn wafer block cleaned by means of the cleaning installation.

A solid-matter discharge may be removed from the centrifuge 104, making possible a recovery of the silicon carbide as well as of remnant constituents that are also recyclable.

The present invention is particularly suitable for cleaning sawn silicon wafer blocks so as to clear off a mixture of silicon carbide, silicon particles, iron particles from the sawing wire, as well as the support medium (e.g. PEG), which is disposed between the disks after the sawing process. However, the present invention may also be employed for cleaning sawn wafer blocks made of other materials.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-22. (canceled)

23: An apparatus for cleaning a sawn wafer block, comprising:
a cleaning basin;
a fixture for holding a sawn wafer block in the cleaning basin such that, when cleaning liquid is present in the cleaning basin, at least a portion of the wafer block comprising sawn gaps is disposed in the cleaning liquid;
at least one outlet port in a bottom region of the cleaning basin; and
a closer for the outlet port, by means of which the outlet port may be opened and closed,
wherein the closer, the outlet port and the bottom region of the cleaning basin are configured such that, by opening the closer, the cleaning liquid is drainable from at least the area of the cleaning basin the wafer block is disposed in so fast that contaminants are removable from the sawn gaps by means of a suction effect of the cleaning liquid,
wherein the outlet port and the closer are configured such that the cleaning basin, starting from a filled state monitored via a sensor, is drainable in less than 2 seconds, advantageously less than 1.5 seconds.

24: The apparatus of claim 23, wherein the fixture is configured to hold the sawn wafer block such that the sawn gaps are oriented substantially vertically.

25: The apparatus of claim 23, wherein the bottom region of the cleaning basin comprises panel regions leading toward the outlet port in inclined an downward manner.

26: The apparatus of claim 25, wherein the cleaning basin comprises two outlet ports, wherein the bottom region between the outlet ports is roof-shaped and comprises surfaces sloping downward toward the outlet ports.

27: An apparatus for cleaning a sawn wafer block, comprising:
a cleaning basin;
a fixture for holding a sawn wafer block in the cleaning basin such that, when cleaning liquid is present in the cleaning basin, at least a portion of the wafer block comprising sawn gaps is disposed in the cleaning liquid;
at least one outlet port in a bottom region of the cleaning basin; and
a closer for the outlet port, by means of which the outlet port may be opened and closed,
wherein the closer, the outlet port and the bottom region of the cleaning basin are configured such that, by opening the closer, the cleaning liquid is drainable from at least the area of the cleaning basin the wafer block is disposed in so fast that contaminants are removable from the sawn gaps by means of a suction effect of the cleaning liquid,
wherein the cleaning basin exhibits a length and a width, wherein the at least one outlet port continuously extends across the entire length of the cleaning basin.

28: The apparatus of claim 27, wherein the cleaning basin comprises no horizontal inner surfaces so as to prevent depositing of contaminants.

29: An apparatus for cleaning a sawn wafer block, comprising:
a cleaning basin;
a fixture for holding a sawn wafer block in the cleaning basin such that, when cleaning liquid is present in the cleaning basin, at least a portion of the wafer block comprising sawn gaps is disposed in the cleaning liquid;
at least one outlet port in a bottom region of the cleaning basin; and
a closer for the outlet port, by means of which the outlet port may be opened and closed,
wherein the closer, the outlet port and the bottom region of the cleaning basin are configured such that, by opening the closer, the cleaning liquid is drainable from at least the area of the cleaning basin the wafer block is disposed in so fast that contaminants are removable from the sawn gaps by means of a suction effect of the cleaning liquid,
wherein the outlet port is formed in a bottom plate of the cleaning basin, wherein the closer comprises a closure element and a driver for moving the closure element in a vertical direction, wherein sealing surfaces of the outlet port, at which the closure element, when same is in a closed position, closes the outlet port, are arranged in an inclined manner so that the outlet port is smaller on the top side of the bottom plate than on the underside thereof, wherein the closure element comprises matching sealing surfaces arranged in an inclined manner.

30: The apparatus of claim 23, comprising a sprayer in the cleaning basin so as to spray cleaning liquid into the sawn gaps from one or two sides.

31: The apparatus of claim 30, comprising a mover for moving the sprayer in a vertical direction.

32: The apparatus of claim 30, wherein the sprayer is configured to spray cleaning liquid into the sawn gap from two sides, wherein a controller is provided so as to control the sprayer to spray alternatingly from both sides.

33: The apparatus of claim 23, further comprising an apparatus for preparing the drained cleaning liquid.

34: The apparatus of claim 33, wherein the apparatus for preparing comprises a centrifuge.

35: A method of cleaning a sawn wafer block, comprising:
introducing the sawn wafer block into a cleaning basin;
filling the cleaning basin with cleaning liquid prior to, during or after introducing the sawn wafer block so that at least a portion of the wafer block comprising sawn gaps is located in the cleaning liquid;
opening at least one outlet port arranged in the bottom region of the cleaning basin, the outlet port and the bottom region of the cleaning basin being formed such that the cleaning liquid, by opening same, is drained so fast that contaminants are removed from the sawn gaps due to a suction effect of the cleaning liquid,
wherein the cleaning basin is drained in less than 2 seconds, advantageously less than 1.5 seconds.

36: The method of claim 35, further comprising spraying cleaning liquid into the sawn gaps before and/or while at least the portion of the wafer block comprising the sawn gaps is located in the cleaning liquid.

37: The method of claim 36, wherein the spraying takes place alternatingly from two sides of the wafer block.

38: The method of claim 36, wherein a sprayer, by means of which the spraying is performed, is moved in a vertical direction during the spraying.

39: The method of claim 35, further comprising preparing the drained cleaning liquid using a centrifuge.

40: The method of claim 35, wherein water is used as the cleaning liquid.

41: The method of claim 40, wherein a surfactant is added to the water.

42: The method of claim 35, further comprising heating the cleaning liquid.
